(19) United States
(12) Patent Application Publication
(10) Pub. No.: US 2025/0271982 A1
(43) Pub. Date: Aug. 28, 2025

(54) PROJECTION METHOD, PROJECTION SYSTEM, AND NON-TRANSITORY COMPUTER-READABLE STORAGE MEDIUM STORING PROGRAM FOR INFORMATION PROCESSING

(71) Applicant: SEIKO EPSON CORPORATION, Tokyo (JP)

(72) Inventors: Junichi WAKABAYASHI, Matsumoto-shi (JP); Reito SATO, Suwa-shi (JP)

(73) Assignee: SEIKO EPSON CORPORATION, Tokyo (JP)

(21) Appl. No.: 19/065,533

(22) Filed: Feb. 27, 2025

(30) Foreign Application Priority Data
Feb. 28, 2024 (JP) 2024-028223

(51) Int. Cl. G06F 3/0484; G06F 3/0481; G06T 11/20; G06T 11/40

(52) U.S. Cl. CPC G06F 3/0484; G06F 3/0481; G06T 11/203; G06T 11/40; G06T 2200/24

(57) ABSTRACT

A projection method includes displaying a user interface for setting an output image based on an original image relating to a road marking, the output image containing a line drawing serving as a reference for painting of the road marking on a road surface, receiving input to set the output image via the user interface, and projecting the output image from an optical device onto the road surface.

The present application is based on, and claims priority from JP Application Serial Number 2024-028223, filed Feb. 28, 2024, the disclosure of which is hereby incorporated by reference herein in its entirety.

### BACKGROUND

### 1. Technical Field

The present disclosure relates to a projection method, a projection system, and a non-transitory computer-readable storage medium storing a program for information processing.

### 2. Related Art

JP-A-2020-180480 discloses a construction device for constructing a road marking on a road surface. The construction device includes a painting unit provided on a lateral side of a vehicle and painting the marking by applying paint on a road surface. Further, the construction device includes a front capturing unit that captures an image of a reference line on the front side of the vehicle among reference lines indicating positions to be painted for application of paint on a road surface, and a front image display unit that displays the image captured by the front capturing unit. After the traveling direction of the vehicle is set to be parallel to the reference line, a guide line parallel to the reference line is displayed in advance in the front image display unit. The guide line is a line serving as a mark for the vehicle to travel in parallel to the reference line when the paint is applied to the road surface of a straight road to construct the road marking.

JP-A-2020-180480 is an example of the related art.

However, JP-A-2020-180480 does not disclose any method of drawing an auxiliary line including the reference line on a road surface for painting a road marking on the road surface. The auxiliary line is generally drawn by manual work. In related art, work efficiency is required.

### SUMMARY

A projection method according to an aspect of the present disclosure includes displaying a user interface for setting an output image based on an original image relating to a road marking, the output image containing a line drawing serving as a reference for painting of the road marking on a road surface, receiving input to set the output image via the user interface, and projecting the output image from an optical device onto the road surface.

A projection system according to an aspect of the present disclosure includes a processing device configured to execute displaying a user interface for setting an output image based on an original image relating to a road marking, the output image containing a line drawing serving as a reference for painting of the road marking on a road surface, receiving input to set the output image via the user interface, and projecting the output image from an optical device onto the road surface.

A non-transitory computer-readable storage medium storing a program for information processing according to an aspect of the present disclosure causes a computer to execute displaying a user interface for setting an output image based on an original image relating to a road marking, the output image containing a line drawing serving as a reference for painting of the road marking on a road surface, receiving input to set the output image via the user interface, and projecting the output image from an optical device onto the road surface.

### BRIEF DESCRIPTION OF THE DRAWINGS

FIG. 1 is a block diagram showing a configuration of a construction assist apparatus.

FIG. 2 is an external view of the construction assist apparatus.

FIG. 3 shows a projection example of an image representing a drawing pattern of a road marking on a road surface.

FIG. 4 shows a guide line.

FIG. 5 is a block diagram showing a configuration example of an information processing device.

FIG. 6 shows an example of a user interface.

FIG. 7 shows masking tape positions.

FIG. 8 shows an object to be detected by a detector.

FIG. 9 shows an object to be detected by the detector.

FIG. 10 shows an object to be detected by the detector.

FIG. 11 shows an object to be detected by the detector.

FIG. 12 shows an object to be detected by the detector.

FIG. 13 shows an object to be detected by the detector.

FIG. 14 shows an object to be detected by the detector.

FIG. 15 shows an object to be detected by the detector.

FIG. 16 shows an object to be detected by the detector.

FIG. 17 shows an object to be detected by the detector.

FIG. 18 shows an object to be detected by the detector.

FIG. 19 shows an object to be detected by the detector.

FIG. 20 shows an object to be detected by the detector.

FIG. 21 is a block diagram showing a configuration example of a projector.

FIG. 22 is a flowchart showing an operation of the information processing device.

### DESCRIPTION OF EMBODIMENTS

As below, configurations for implementing the present disclosure will be described with reference to the drawings. Note that, the respective drawings, dimensions and scales of the respective parts are made different from real ones as appropriate. Further, the following embodiments are preferable specific examples of the present disclosure and various technically preferable limitations are imposed thereon, however, the scope of the present disclosure is not limited to the embodiments without description that particularly limits the present disclosure in the following explanation.

### 1: First Embodiment

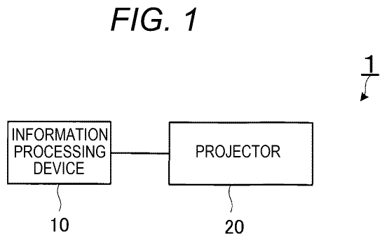

As below, a projection method according to the embodiment will be described with reference to FIGS. 1 to 22.

### 1-1: Overall Configuration

FIG. 1 is a block diagram showing a configuration of a construction assist apparatus 1 that executes the projection method according to the embodiment. The construction assist 1 includes an information processing device 10 and a projector 20. The information processing device 10 and the projector 20 are communicably connected to each other.

The construction assist apparatus 1 is an apparatus that projects an image representing a drawing pattern used for drawing on a road surface RS when a road marking RM is drawn on the road surface RS. The drawing pattern includes an outline of the road marking RM drawn on the road surface RS as an example. The drawing pattern may further include an auxiliary image AI for drawing the road marking RM. The road marking RM is drawn by, for example, a user U of the construction assist apparatus 1 applying paint on the road surface RS using a known painting apparatus different from the construction assist apparatus 1.

The projector 20 is a device that projects an image representing the drawing pattern onto the road surface RS. The information processing device 10 is a device that controls the projector 20. The information processing device 10 controls the projector 20, and thereby, the projector 20 projects an image representing a drawing pattern on the road surface RS.

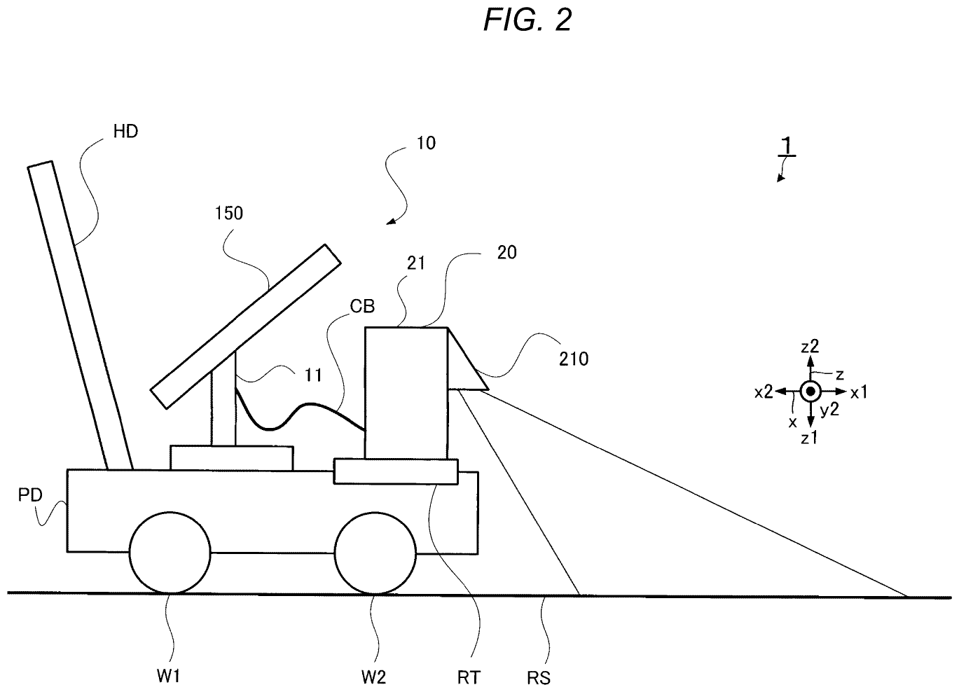

FIG. 2 is an example of an external view of the construction assist apparatus 1 according to the embodiment.

In FIG. 2, an xyz space formed by three axes of an x axis, a y axis, and a z axis is assumed. The x axis, the y axis, and the z axis are orthogonal to one another. In the xyz space, the z-axis direction is a vertical direction. The z-axis direction collectively refers to a z1 direction and a z2 direction opposite to the z1 direction. The z1 direction is a vertically downward direction. The z2 direction is a vertically upward direction. The x-axis direction is the same direction as a direction of a symmetry line of the construction assist apparatus 1 on the xy-plane. The x-axis direction collectively refers to an x1 direction and an x2 direction opposite to the x1 direction. The x1 direction is a direction anterior to the construction assist apparatus 1. The x2 direction is a direction posterior to the construction assist apparatus 1. More specifically, in the construction assist apparatus 1, of a first position in which the information processing device 10 is provided and a second position in which the projector 20 is provided, the first position is located in the x2 direction with respect to the second position. The y-axis direction collectively refers to a y1 direction and a y2 direction. The y1 direction is a rightward direction when the xy-plane is seen in the z1 direction with the x1 direction upward. The y2 direction is a leftward direction when the xy-plane is seen in the z1 direction with the x1 direction upward.

In FIG. 2, the construction assist apparatus 1 includes a pedestal PD. The pedestal PD includes wheels W1 and W2 on a surface of the pedestal PD in the z1 direction. The pedestal PD is movable on the road surface RS with the wheels W1 and the wheels W2. The pedestal PD is provided with a handle HD. The user U of the construction assist apparatus 1 moves the pedestal PD on the road surface RS by gripping the handle HD and applying a force to the pedestal PD.

The information processing device 10 and the projector 20 are placed on the pedestal PD in the z2 direction with respect to the pedestal PD. The information processing device 10 and the projector 20 are communicably connected to each other by a cable CB.

The information processing device 10 includes a main body 11 and a display device 150. The main body 11 includes a processing device 120, which will be described later. The display device 150 is placed in the z2 direction with respect to the main body 11.

The display device 150 is a device that displays images and character information. The display device 150 displays various images under the control by the processing device 120. For example, various display panels such as a liquid crystal display panel and an organic EL (Electro Luminescence) display panel are suitably used as the display device 150.

The user U of the construction assist apparatus 1 can visually recognize various images and character information displayed on the display device 150 while gripping the handle HD.

A rotary table RT is placed on a surface of the pedestal PD in the z2 direction. The rotary table RT is located in the x1 direction with respect to the information processing device 10. The rotary table RT rotates by 360° around an axis in the z-axis direction.

The projector 20 is mounted on a surface of the rotation base RT in the z2 direction. The projector 20 includes a main body 21 and a projection device 210. The main body 21 includes a processing device 220, which will be described later, and at least a part of the projection device 210. The main body 21 has, for example, a cylindrical shape around the z axis direction as a center axis. For example, a part of the projection device 210 and an opening for emitting light from the projection device 210 are placed on a side surface of the main body 21.

The projection device 210 is a device that projects an image generated by the information processing device 10 onto the road surface RS. In the example shown in FIG. 2, the projection device 210 projects the image in the x1 direction. However, the projector 20 provided with the projection device 210 is mounted on the rotary table RT, and the projector 20 rotates on the rotary table RT. Accordingly, the projector 20 can project an image generated by the information processing device 10 in any direction of the x1 direction, the x2 direction, the y1 direction, and the y2 direction. Further, the projector 20 can project an image generated by the information processing device 10 in any direction between the x1 direction and the y2 direction, any direction between the y2 direction and the x2 direction, any direction between the x2 direction and the y1 direction, and any direction between the y1 direction and the x1 direction.

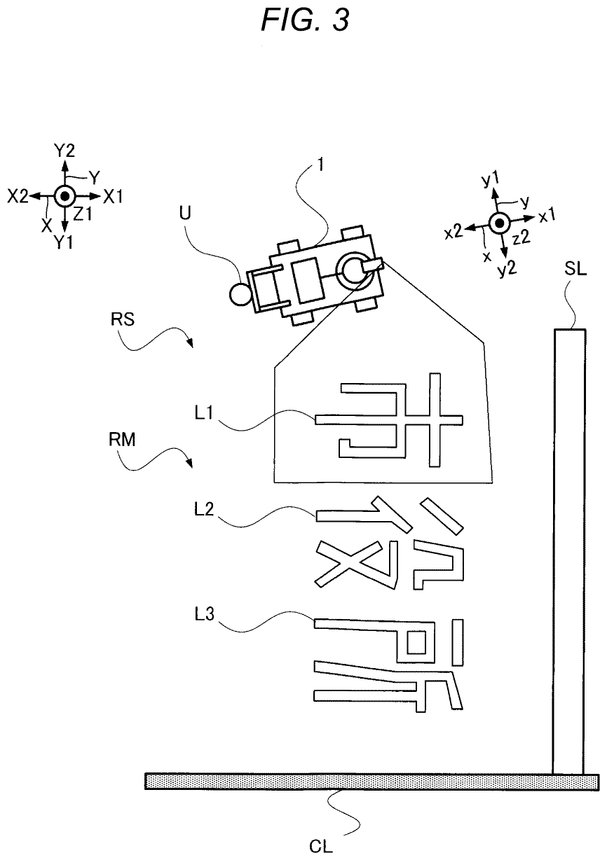

FIG. 3 shows a projection example of an image showing a drawing pattern of the road marking RM with respect to the road surface RS by the construction assist apparatus 1.

In FIG. 3, an XYZ space formed by three axes of an X axis, a Y axis, and a Z axis is assumed. The X axis, the Y axis, and the Z axis are orthogonal to one another. In the XYZ space, the Z axis direction is the vertical direction. The Z-axis direction collectively refers to a Z1 direction and a Z2 direction opposite to the Z1 direction. The Z1 direction is a vertically downward direction. The Z2 direction is a vertically upward direction. The X-axis direction is an extension direction of a road center line CL drawn on the road surface RS. The X-axis direction collectively refers to an X1 direction and an X2 direction opposite to the X1 direction. The X1 direction is a direction toward the top of the road marking RM. The X2 direction is a direction facing the bottom of the road marking RM. The Y-axis direction is an extension direction of a stop line SL drawn on the road surface RS. The Y-axis direction collectively refers to a Y1 direction and a Y2 direction. The Y1 direction is a rightward direction when the road surface RS is seen in the Z1 direction with the X1 direction upward. The Y2 direction is a leftward direction when the road surface RS is seen in the Z1 direction with the X1 direction upward.

In the example shown in FIG. 3, the road marking RM includes three characters of a first character L1, a second character L2, and a third character L3. More specifically, in the example shown in FIG. 3, the road marking RM indicates three characters of “ [symbol] ”. The first character L1 indicates the character “ [symbol] ” of “ [symbol] ”. The second character L2 indicates a character “ [symbol] ” of “ [symbol] ”. The third character L3 indicates a character “ [symbol] ” of “ [symbol] ”. However, the road marking RM may include any number of characters. Further, the road marking RM may be any character. Furthermore, the road marking RM may include a figure other than characters. In FIG. 3, the second character L2 and the third character L3 are shown for explanation. The two characters are not constructed on the road surface RS at the time when the first character L1 is projected, and the user U can visually recognize only the image of the first character L1 on the road surface RS of the three characters.

The construction assist apparatus 1 projects the road marking RM on the road surface RS one character at a time. In the example shown in FIG. 3, the construction assist apparatus 1 projects the outline of the first character L1 of the road marking RM in an area in the Y2 direction with respect to the road center line CL and in the X2 direction with respect to the stop line SL on the road surface RS. The details of the method of projecting the outline of the first character L1 by the construction assist apparatus 1 will be described later.

In FIGS. 2 and 3, the road surface RS may be an outdoor road surface or an indoor road surface. In FIGS. 2 and 3, the construction assist apparatus 1 projects the outline of the first character L1 onto the road surface RS, but this is merely an example. The construction assist apparatus 1 may project the outline of the first character L1 onto a construction surface other than the road surface. For example, the construction assist apparatus 1 may project the outline of the first character L1 onto construction surfaces of a multistory parking lot and a playground.

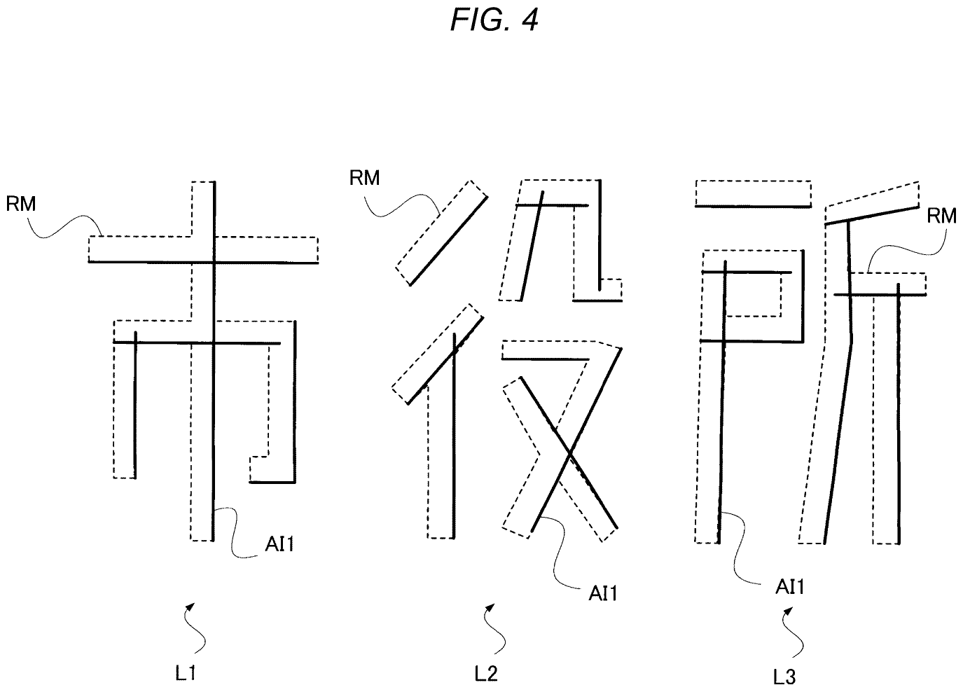

FIG. 4 shows a guide line AI1 as an example of the auxiliary image AI projected on the road surface RS together with the road marking RM. In FIG. 4, the outline of the road marking RM is indicated by dotted lines, and the guide line AI1 is indicated by a solid line. “Guide line” is a line serving as a reference when the road marking RM is manually painted on the road surface RS, and includes at least a part of the outline of the road marking RM.

In a general painting method of the road marking RM, a worker manually draws a chalk line as a guide line using a marker. Since the drawing of the guide line by the chalk line occupies a larger amount of the construction time for painting the road marking RM, work efficiency is required. Further, since an artisan skill is necessary for drawing of a chalk line as a guide line, a method that enables even a beginner to easily draw a guide line is required.

According to the projection method of the present disclosure, the guide line AI1 is projected on the road surface RS, and thereby, work efficiency is increased and the guide line AI1 can be drawn even by a beginner. Note that the projection method of the present disclosure can also be used for painting of the road marking RM without drawing the guide line AI1 using an output image OI displayed on the road surface RS instead of the guide line AI1. Also, in this case, an effect that the road marking RM can be constructed even by a beginner can be obtained.

### 1-2: Configuration of Information Processing Device

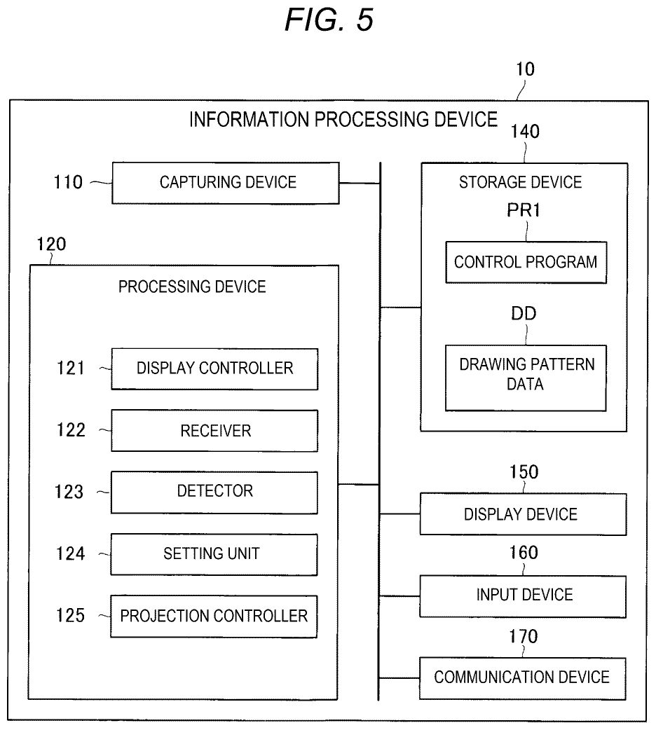

FIG. 5 is a block diagram showing a configuration example of the information processing device 10. The information processing device 10 is typically a PC (Personal Computer), but is not limited thereto, and may be a tablet terminal or a smartphone, for example. The information processing device 10 includes a capturing device 110, the processing device 120, a storage device 140, the display device 150, an input device 160, and a communication device 170. The respective elements of the information processing device 10 are connected to one another by a single bus or a plurality of buses for communicating information.

The capturing device 110 is a device that captures the road surface RS. The capturing device 110 captures various images under the control of the processing device 120. For example, a camera provided in a PC, a tablet terminal, or a smartphone is preferably used as the capturing device 110, but the device is not limited thereto. An external camera such as a WEB camera may be employed.

The processing device 120 is a processor that controls the entire information processing device 10, and includes, for example, a single chip or a plurality of chips. The processing device 120 includes, for example, a central processing unit (CPU) including an interface with a peripheral device, an arithmetic device, a register, and the like. Apart or all of the functions of the processing device 120 may be implemented by hardware such as a DSP (Digital Signal Processor), an ASIC (Application Specific Integrated Circuit), a PLD (Programmable Logic Device), or an FPGA (Field Programmable Gate Array). The processing device 120 executes various kinds of processing in parallel or sequentially.

The storage device 140 is a storage medium that can be read and written by the processing device 120, and stores a plurality of programs including a control program PR1 executed by the processing device 120 and drawing pattern data DD. The storage device 140 may include at least one of a ROM (Read Only Memory), an EPROM (Erasable Programmable ROM), an EEPROM (Electrical Erasable Programmable ROM), and a RAM (Random Access Memory), for example. The storage device 140 may be referred to as a register, a cache, a main memory, or a main storage device.

The drawing pattern data DD is data related to a drawing pattern. In the embodiment, the drawing pattern is an outline of the road marking RM. In the example shown in FIG. 3, the drawing pattern includes outlines of three characters “ [symbol] ” as the road marking RM. The drawing pattern includes outlines of various road markings other than the road marking RM shown in FIG. 3.

As described above, the display device 150 is a device that displays images and character information. The display device 150 may be a display device separate from the other component elements of the information processing device 10.

The input device 160 is a device that receives an operation from the user U. For example, the input device 160 includes a pointing device such as a keyboard, a touch pad, a touch panel, or a mouse. When including a touch panel, the input device 160 may also serve as the display device 150.

The communication device 170 is hardware serving as a transmitting and receiving device for communicating with another device. The communication device 170 is also called, for example, a network device, a network controller, a network card, or a communication module. The communication device 170 may include a connector for wired connection and an interface circuit corresponding to the connector. The communication device 170 may include a wireless communication interface. Examples of the connector and the interface circuit for wired connection include those conforming to a wired LAN (Local Area Network), IEEE 1394, and a USB (Universal Serial Bus). Further, examples of the wireless communication interface include an interface conforming to a wireless LAN or Bluetooth (registered trademark).

The processing device 120 functions as a display controller 121, a receiver 122, a detector 123, a setting unit 124, and a projection controller 125 by reading and executing the control program PRI from the storage device 140. Note that the control program PRI may be transmitted from another apparatus such as a server that manages the information processing device 10 via a communication network.

The display controller 121 displays a user interface UI on the display device 150. The user interface UI is used for setting the output image OI containing a line drawing serving as a reference for painting of the road marking RM on the road surface RS based on an original image relating to the road marking RM. Here, “original image” is a character pattern LP represented by the drawing pattern data DD in the storage device 140. Further, the above described guide line AI1 is an example of “a line drawing serving as a reference for painting of the road marking RM”.

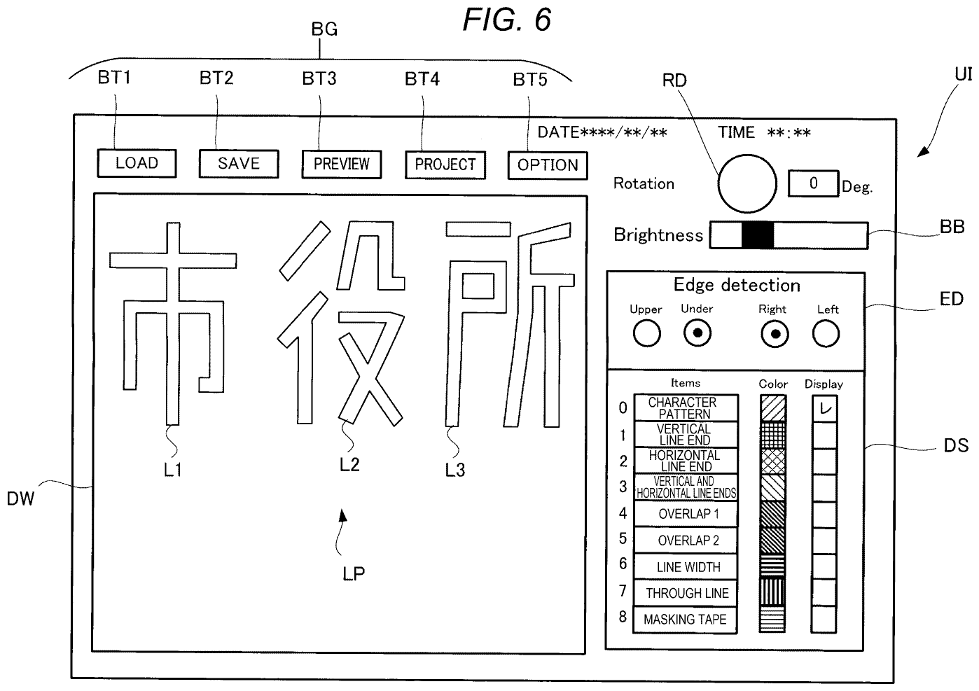

FIG. 6 shows an example of the user interface UI. The user interface UI includes a button group BG, a display window DW, a rotary dial RD, an edge detection setting field ED, and a display setting field DS.

The button group BG includes first to fifth buttons BT1 to BT5.

The first button BT1 is a button for loading the drawing pattern data DD in the storage device 140. The character pattern LP represented by the read drawing pattern data DD is displayed in the display window DW.

The second button BT2 is a button for saving processed data after the character pattern LP displayed in the display window DW is processed by the user U operating an operator including the rotary dial RD, the edge detection setting field ED, and the display setting field DS contained in the user interface UI.

The third button BT3 is a button for display of a completion drawing of the road marking RM as a preview image in the display window DW based on input by the user U to the user interface UI. The preview image has the same outline as the character pattern LP, and includes a painting image in which the inside of the same outline is filled with a painting color.

The fourth button BT4 is a button for projection of the output image OI set based on input by the user U to the user interface UI from the projector 20. The output image OI may be an image showing the completion drawing of the road marking RM displayed in the display window DW as the preview.

The fifth button BT5 is a button for use of a function as an option. The optional function may be, for example, a function of increasing or decreasing items displayed in the display setting field DS, which will be described later. Or, the optional function may be a function of displaying an operator for inputting a length of each of a first-type overlap OL1 and a second-type overlap OL2, which will be described later, on the user interface UI. Or, the optional function may be a function of switching the output image OI to be projected on the road surface RS among an image including only the character pattern LP, an image including only the guide line AI1, an image including only a masking tape position AI2, and an image in which two or more of the three elements are superimposed. Or, the optional function may be a function of projecting a painting image in which the inside of the outline of the character pattern LP is filled with a painting color on the road surface RS from the projector 20 separately from the output image OI.

In the display window DW, a plurality of elements including the character pattern LP and the guide line AI1 are displayed. Whether each of the plurality of elements is displayed is set by the display setting field DS.

The rotary dial RD is a dial for rotating the character pattern LP displayed in the display window DW. The user U rotates the character pattern LP displayed in the display window DW by rotating the rotary dial RD. A rotation angle is displayed at the right side of the rotary dial RD.

The edge detection setting field ED is a field for setting of a method of detecting an edge EG. “Edge EG” is one or more of an upper end, a lower end, a right end, and a left end contained in the elements forming each of the first character L1, the second character L2, and the third character L3 contained in the character pattern LP. Two radio buttons at the left side are used for setting which one of the upper end and the lower end of the m-th stroke forming each of the first character L1, the second character L2, and the third character L3 is detected as the edge EG. Two radio buttons at the right side are used for setting which of the right end and the left end of the n-th stroke forming each of the first character L1, the second character L2, and the third character L3 contained in the character pattern LP is detected as the edge EG. Each of m and n is an integer of 1 or more. Unless otherwise specified, m=n or m≠n.

The display setting field DS is a field for setting which element is displayed in the display window DW among a plurality of elements related to the character pattern LP. In the example shown in FIG. 6, the display setting field DS is used for setting whether to display the character pattern LP, a vertical line end, a horizontal line end, vertical and horizontal line ends, an overlap 1, an overlap 2, a line width portion, a through line, and the masking tape.

The “character pattern” field is used for setting whether to display the entire outline of the character pattern LP in the display window DW. In order to indicate that the entire outline of the character pattern LP is displayed, “CHARACTER PATTERN” is displayed in an “Items” field. Further, a first color is displayed in a “Color” field located at the right side of the “Items” field. The “Color” field indicates that, when the entire outline of the character pattern LP is displayed in the display window DW, the outline is displayed in the first color. In the check box located in the right field of “Color”, whether to display the entire outline of the character pattern LP is input. When the check box is checked, display of the entire outline of the character pattern LP is selected.

The “vertical line end” field is used for setting whether to display a vertical line edge EGv among the “edges EG” in the display window DW. The vertical line edge EGv is a part of the guide line AI1. In order to indicate that the vertical line edge EGv is displayed, “VERTICAL LINE END” is displayed in the “Items” field. A second color is displayed in the “Color” field located at the right side of the “Items” field. The “Color” field indicates that, when the vertical line edge EGv is displayed in the display window DW, the vertical line edge EGv is displayed in the second color. In the check box located in the right field of “Color”, whether to display the vertical line edge EGv is input. When the check box is checked, display of the vertical line edge EGv is selected. In the present disclosure, “vertical line” refers to a line having an absolute value of an angle formed between a vertical straight line and itself is 45 degrees or less. In the following description, the colors of the respective numbers are different from one another.

The “horizontal line end” field is used for setting whether to display a horizontal line edge EGb among the “edges EG” in the display window DW. The horizontal line edge EGb is a part of the guide line AI1. In order to indicate that the horizontal line edge EGb is displayed, “HORIZONTAL LINE END” is displayed in the “Items” field. A third color is displayed in the “Color” field located at the right side of the “Items” field. The “Color” field indicates that, when the edge EGb of the horizontal line is displayed in the display window DW, the horizontal line edge EGb is displayed in the third color. In the check box located in the right field of “Color”, whether to display the horizontal line edge EGb is input. When the check box is checked, display of the horizontal line edge EGb is selected. In the present disclosure, “horizontal line” refers to a line that an absolute value of an angle formed between a horizontal straight line and itself is less than 45 degrees.

The “vertical and horizontal line ends” field is used for setting whether to display a corner edge EGc contained in both the vertical line edge EGv and the horizontal line edge EGb among the “edges EG” in the display window DW. The corner edge EGc is a part of the guide line AI1. In order to indicate that the corner edge EGc is displayed, “VERTICAL AND HORIZONTAL LINE EDGES” is displayed in the “Items” field. A fourth color is displayed in the “Color” field located at the right side of the “Items” field. The “Color” field indicates that, when the corner edge EGc is displayed in the display window DW, the corner edge EGc is displayed in the fourth color. In the check box located in the right field of “Color”, whether to display the corner edge EGc is input. When the check box is checked, display of the corner edge EGc is selected.

The “overlap 1” field is used for setting whether to display the first-type overlap OL1 in the display window DW. Here, when the m-th stroke forming each of the first character L1, the second character L2, and the third character L3 is a vertical line, “first-type overlap OL1” refers to the guide line AI1 of the horizontal line of the n-th stroke starting from the center of the width of the m-th stroke and in contact with the m-th stroke. Note that “the m-th stroke is a vertical line” means that the line indicating the longitudinal direction of the m-th stroke is a vertical line. In order to indicate that the first-type overlap OL1 is displayed, “OVERLAP 1” is displayed in the “Items” field. A fifth color is displayed in the “Color” field located at the right side of the “Items” field. The “Color” field indicates that, when the first-type overlap OL1 is displayed in the display window DW, the first-type overlap OL1 is displayed in the fifth color. In the check box located in the right field of “Color”, whether to display the first-type overlap OL1 is input. When the check box is checked, display of the first-type overlap OL1 is selected. In “overlap 1”, m≠n.

The “overlap 2” field is used for setting whether to display the second type overlap OL2 in the display window DW. Here, when the m-th stroke forming each of the first character L1, the second character L2, and the third character L3 is a horizontal line, “second-type overlap OL2” refers to the guide line AI1 of the vertical line of the n-th stroke starting from the center of the width of the m-th stroke and in contact with the m-th stroke. Note that “the m-th stroke is a horizontal line” means that the line indicating the longitudinal direction of the m-th stroke is a horizontal line. In order to indicate that the second-type overlap OL2 is displayed, “OVERLAP 2” is displayed in the “Items” field. Like the case of “overlap 1”, the fifth color is displayed in the “Color” field located at the right side of the “Items” field. The “Color” field indicates that, when the second-type overlap OL2 is displayed in the display window DW, the second-type overlap OL2 is displayed in the fifth color. In the check box located in the right field of “Color”, whether to display the second type overlap OL2 is input. When the check box is checked, display of the second-type overlap OL2 is selected.

The “line width” field is used for setting whether to display the line width LW in the display window DW. Here, “line width LW” refers to a portion indicating the line width of the m-th stroke in the end of the m-th stroke forming each of the first character L1, the second character L2, and the third character L3. Note that “end” here is not an edge, but a start portion or an end portion of the m-th stroke as a line having a width. Unlike the character pattern LP as the original image, the line width LW is an example of an auxiliary line AL that assists the painting of the road marking RM. In order to indicate that the line width LW is displayed, “LINE WIDTH” is displayed in the “Items” field. A sixth color is displayed in the “Color” field located at the right side of the “Items” field. The “Color” field indicates that, when the line width LW is displayed in the display window DW, the line width LW is displayed in the sixth color. In the check box located in the right field of “Color”, whether to display the line width LW is input. When the check box is checked, display of the line width LW is selected.

The “through line” field is used for setting whether to display the through line PL in the display window DW. Here, when m≠n, the m-th stroke is a horizontal line, the n-th stroke is a vertical line, and the end of the m-th stroke is in contact with the end of the n-th stroke in each of the first character L1, the second character L2, and the third character L3, “through line PL” refers to a line that passes through the n-th stroke in the line width direction across the end of the n-th stroke from the end of the m-th stroke. Alternatively, when the m-th stroke is a vertical line, the n-th stroke is a horizontal line, and the end of the m-th stroke contacts the end of the n-th stroke, “through line PL” refers to a line that passes through the n-th stroke in the line width direction across the end of the n-th stroke from the end of the m-th stroke. Note that “end” here is not an edge, but a start portion or an end portion of the m-th stroke and the n-th stroke as lines having widths. The through line PL is a part of the guide line AI1. In order to indicate that the through line PL is displayed, “THROUGH LINE” is displayed in the “Items” field. A seventh color is displayed in the “Color” field located at the right side of the “Items” field. The “Color” field indicates that, when the through line PL is displayed in the display window DW, the through line PL is displayed in the seventh color. In the check box located in the right field of “Color”, whether to display the through line PL is input. When the check box is checked, display of the through line PL is selected.

The “masking tape” field is used for setting whether to display the masking tape position AI2 in the display window DW. Here, “masking tape” is an example of an attached object attached to the road surface RS in order to define the outline of the painting when the road marking RM is painted.

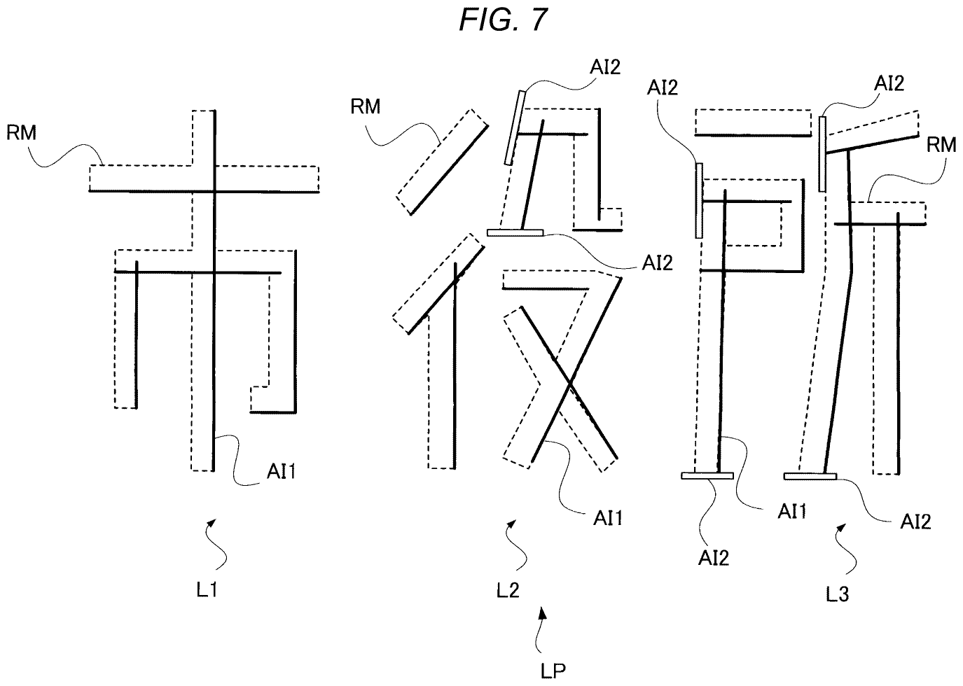

FIG. 7 shows the masking tape positions AI2 as an example of the auxiliary images AI projected on the road surface RS together with the road markings RM and the guide lines AI1. In FIG. 7, the outline of the road marking RM is indicated by a dotted line, the guide line AI1 is indicated by a solid line, and the masking tape position AI2 is indicated by a rectangle.

When the road marking RM is painted by a device painting the road marking RM, for example, ends of the drawing start and the drawing end of the m-th stroke contained in the first character L1 are at right angles. This is because the device painting the road marking RM generally ejects paint in a constant width. For this reason, it is necessary for a worker who draws the road marking RM to attach a masking tape to a portion where the end is not at a right angle. In the example shown in FIG. 7, the ends of the fourth stroke, the end of the fifth stroke of the character “ [symbol] ” as the second character L2 and the end of the second stroke, the end of the fourth stroke, the end of the fifth stroke, and the end of the sixth stroke of the character “ [symbol] ” as the third character L3 correspond to ends not at right angles. Although not shown in FIG. 7, for example, when an oblique line and a horizontal line start from the same point, the end of the horizontal line at the start point corresponds to the end not at a right angle. It is necessary for the worker who draws the road marking RM to attach the masking tape to the ends not right angles. Further, the worker may attach a masking tape to a portion where the clearance between the characters is equal to or less than a predetermined interval. Note that “end” here is not an edge, but a start portion or an end portion of the m-th stroke and the n-th stroke as lines having widths.

A rectangle indicating the masking tape position AI2 is an example of “indication image”. In order to indicate that the masking tape position AI2 is displayed, “MASKING TAPE” is displayed in the “Items” field. An eighth color is displayed in the “Color” field located at the right side of the “Items” field. The “Color” field indicates that, when the masking tape position AI2 is displayed in the display window DW, the position is displayed in the eighth color. In the check box located in the right field of “Color”, whether to display the masking tape position AI2 is input. When the check box is checked, display of the masking tape position AI2 is selected. The masking tape position AI2 may have a rectangular shape as shown in FIG. 7, or may have another shape. The other shape may be, for example, a circular shape.

Note that, in FIG. 6, for convenience of description, the first to eighth colors are shown by different patterns. Hereinafter, for convenience of description, the pattern corresponding to the first color is referred to as “first pattern”. Similarly, the respective patterns corresponding to the second to eighth colors are referred to as “second pattern” to “eighth pattern”. The first to eighth colors correspond to “first pattern” to “eighth pattern” on a one-to-one basis.

In FIG. 5, the receiver 122 receives input from the user U for setting the output image OI via the user interface UI. The input is based on an operation of the user U on the user interface UI via the input device 160. As described above, “an operation by the user U” is an operation for the operator contained in the user interface UI.

The input from the user U received by the receiver 122 includes at least one of input to select a part of the outline of the character pattern LP as the original image, input to select all of the character pattern LP, input to select whether to display the indication image indicating the position AI2 to which the masking tape is attached on the road surface RS, and input to select whether to display the auxiliary line AL for assisting the painting of the road marking RM different from the character pattern LP. Here, the guide line AI1 is an example of “a part of the outline of the character pattern LP as the original image”.

When the input from the user U received by the receiver 122 is input to select the guide line AI1 as a part of the outline of the character pattern LP as the original image, the input includes input to select at least one of the vertical line edge EGv and the horizontal line edge EGb among the guide lines AI1. Here, the vertical line edge EGv is an example of “a straight line in the first direction of the outline of the original image”. The horizontal line edge EGb is an example of “a straight line in a second direction orthogonal to the first direction of the outline of the original image”.

When the input from the user U received by the receiver 122 includes input to select at least one of the vertical line edge EGv and the horizontal line edge EGb among the guide lines AI1, the receiver 122 may receive input to select whether to extend one of the vertical line edge EGv and the horizontal line edge EGb to the inside of the character pattern LP as the original image at the intersection of the vertical line edge EGv and the horizontal line edge EGb. Here, a portion as the extension of the vertical line edge EGv to the inside of the character pattern LP as the original image corresponds to the “second-type overlap OL2”. Further, a portion as the extension of the horizontal line edge EGb to the inside of the character pattern LP as the original image corresponds to the “first-type overlap OL1”.

In this case, the receiver 122 may receive input indicating an amount of extension of one of the vertical line edge EGv and the horizontal line edge EGb to the inside of the character pattern LP as the original image. In other words, the receiver 122 may receive the lengths of the “first-type overlap OL1” and the “second-type overlap OL2”.

The input from the user U received by the receiver 122 includes input to select display of the preview image as the completion drawing of the road marking RM. The preview image includes a painting image in which the inside of the outline of the character pattern LP is filled with a painting color.

The detector 123 detects an element related to the character pattern LP as the original image. “An element related to the character pattern LP” includes, for example, at least one of the “edge EG”, the “guide line AI1”, the “character pattern LP”, the “vertical line edge EGv”, the “horizontal line edge EGb”, the “first-type overlap OL1”, the “second-type overlap OL2”, the “line width LW”, the “through line PL”, and the “masking tape position AI2”.

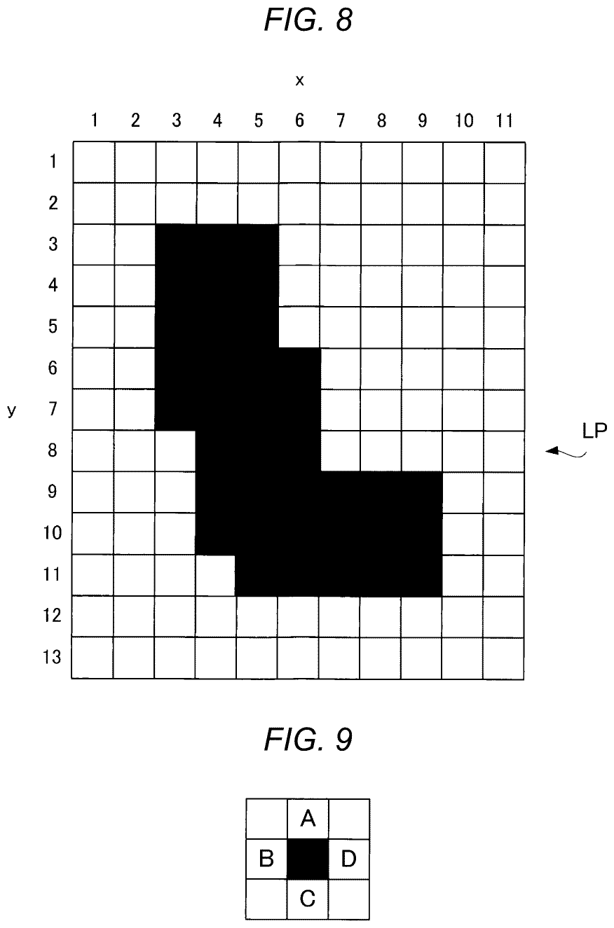

FIGS. 8 to 20 show objects to be detected by the detector 123. As below, the operation of the detector 123 will be described with reference to FIGS. 8 to 20. In the following description, as shown in FIG. 6, it is assumed that detection of the lower end and the right end as the edges EG is set in the edge detection setting field ED.

FIG. 8 shows a part of the character pattern LP. In FIG. 8, grids contained in the character pattern LP are painted black. Further, in FIG. 8, in order to indicate the position of each grid, x-y coordinates with an x axis in the horizontal direction and a y axis in the vertical direction in FIG. 8 are set. On the x axis, as the position moves from left to right, the grid number is incremented by one. Further, on the y axis, as the position moves from top to bottom, the grid number is incremented by one. The detector 123 detects the shape of the character pattern LP based on whether each grid is painted black.

In FIG. 9, with the center grid as “grid of interest” contained in the character pattern LP, the detector 123 detects the type of the grid of interest according to whether there is another grid contained in the character pattern LP on the upside, downside, left side, and right side of the grid of interest. Specifically, in FIG. 9, a grid adjacent to the grid of interest at the upside is referred to as “grid A”, a grid adjacent at the left side is referred to as “grid B”, a grid adjacent at the downside is referred to as “grid C”, and a grid adjacent at the right side is referred to as “grid D”. The detector 123 detects “grid of interest” for which only the grid B is contained in the character pattern LP of the grid A and the grid B as “horizontal edge EGv”. Further, the detector 123 detects “grid of interest” for which only the grid A is contained in the character pattern LP of the grid A and the grid B as “vertical line edge EGb”. Furthermore, the detector 123 detects “grid of interest” for which both the grid A and the grid B are contained in the character pattern LP as “corner edge EGc”.

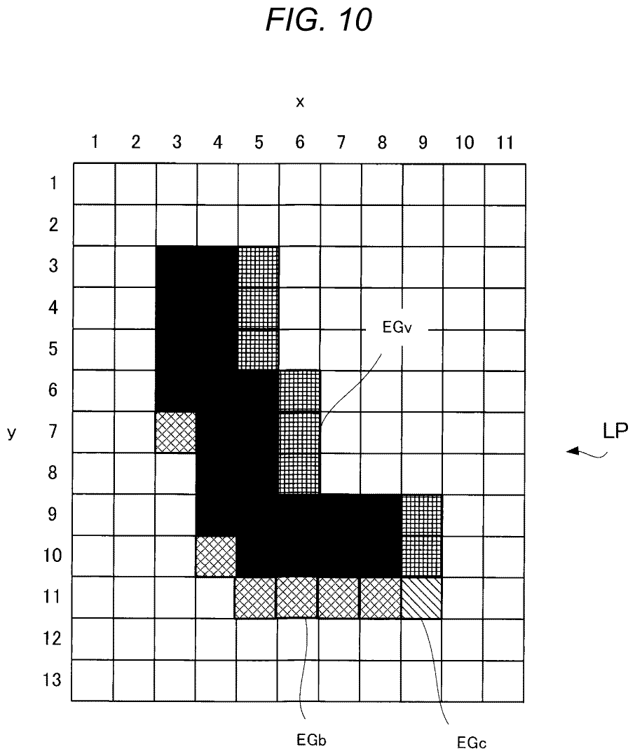

FIG. 10 shows a result of application of an algorithm shown in FIG. 9 to the part of the character pattern LP shown in FIG. 8. Here, in FIG. 10, the vertical line edge EGv is indicated by the second pattern, the horizontal line edge EGb is indicated by the third pattern, and the corner edge EGc is indicated by the fourth pattern.

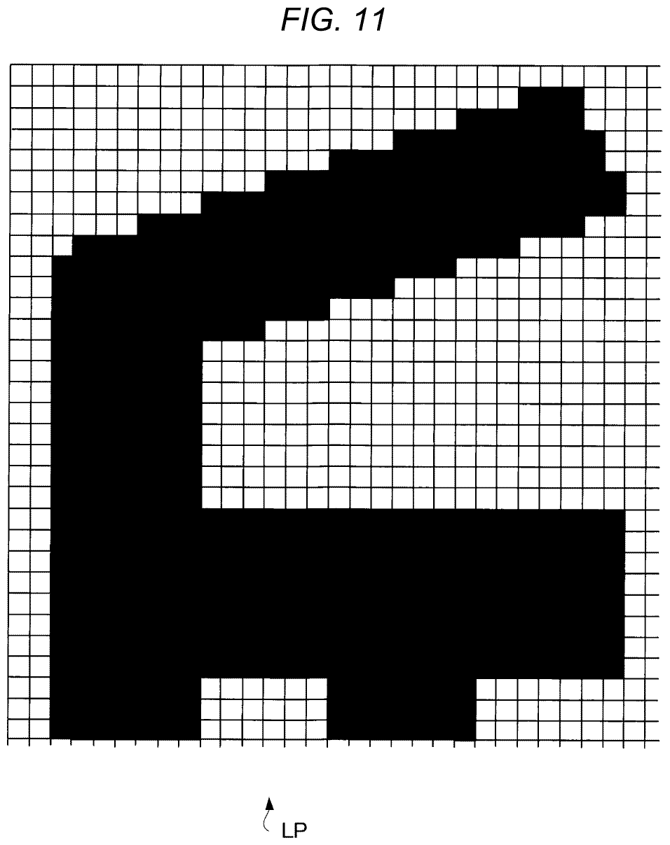

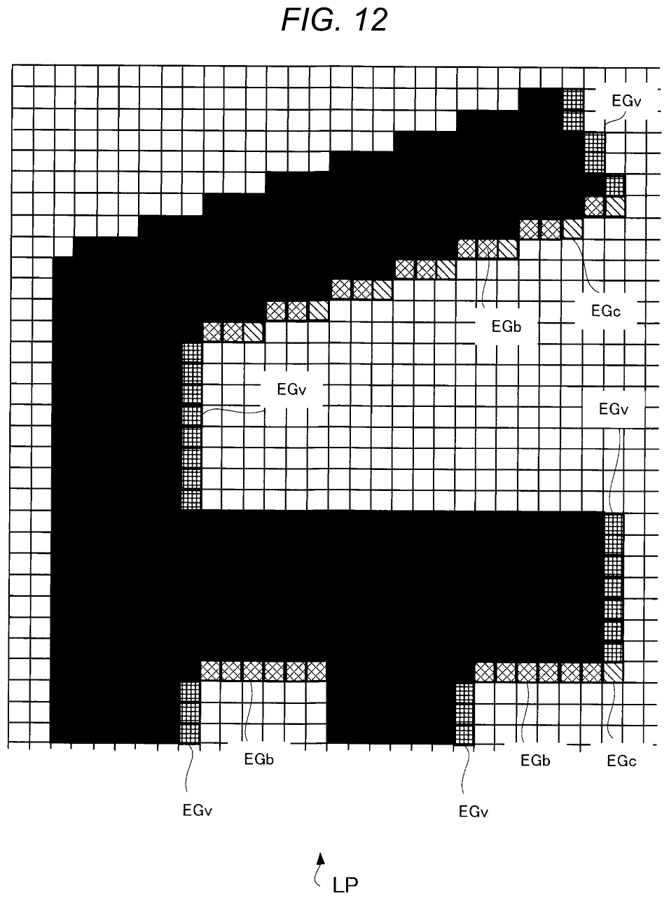

FIG. 11 shows the upper right part of “ [symbol] ” as the third character L3 of the character pattern LP. FIG. 12 shows a result of application of the algorithm shown in FIG. 9 to the part of the character pattern LP shown in FIG. 11.

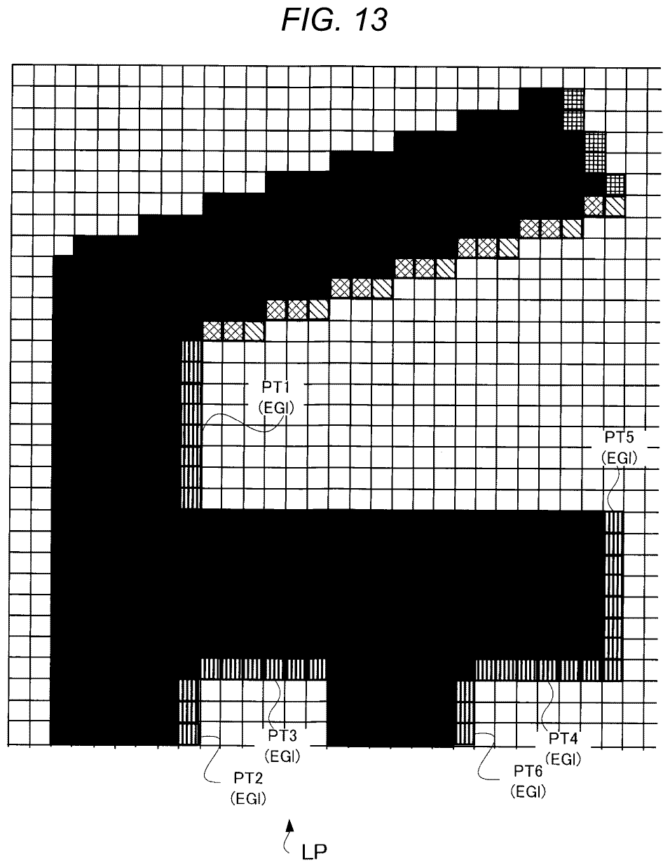

Then, the detector 123 detects a linear edge EGl among the vertical line edge EGv, the horizontal line edge EGb, and the corner edge EGc in FIG. 12. As an example, the detector 123 detects the edge EG vertically or horizontally continuing over five or more grids among the vertical line edge EGv, the horizontal line edge EGb, and the corner edge EGc as the linear edge EGl. In the example shown in FIG. 13, the detector 123 detects a first portion PT1 to a sixth portion PT6 as the linear edges EGl. These linear edges EGl are indicated using the seventh pattern in FIG. 13.

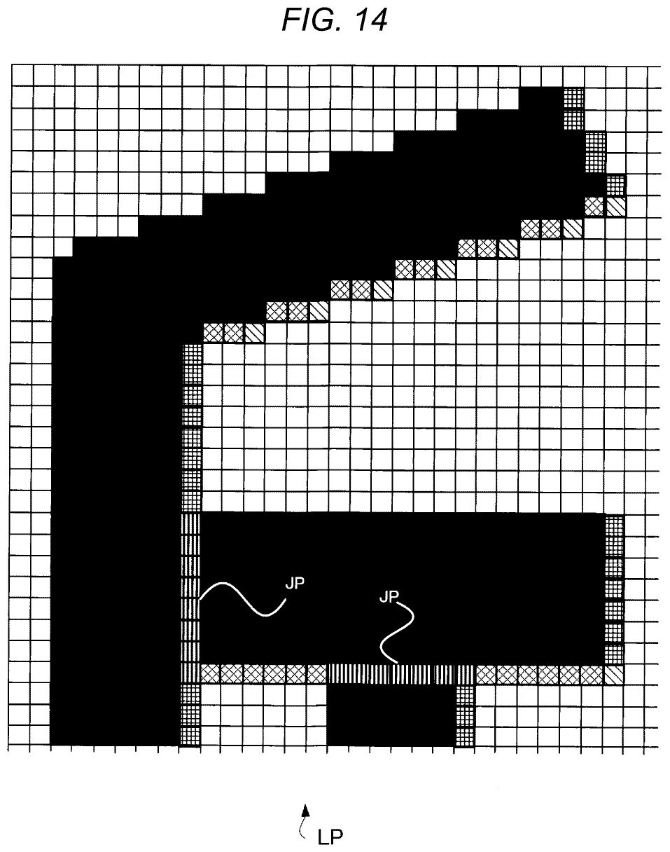

Then, when another linear edge EGl is present in a position separated by a predetermined number of grids from the end of the linear edge EGl, the detector 123 connects the linear edges EGl. Here, “predetermined number of grids” is, for example, the number of grids equal to or larger than those of the line width of the m-th stroke forming the character pattern LP. In the example shown in FIG. 13, the detector 123 connects the first portion PT1 and the second portion PT2. Further, the detector 123 connects the third portion PT3 and the fourth portion PT4. FIG. 14 shows a result of the detector 123 connecting the first portion PT1 and the second portion PT2, and the third portion PT3 and the fourth portion PT4. Note that, in FIG. 14, the portions indicated using the seventh pattern in FIG. 13 are indicated by the same pattern as in FIG. 12, and connection portions JP are indicated by the seventh pattern.

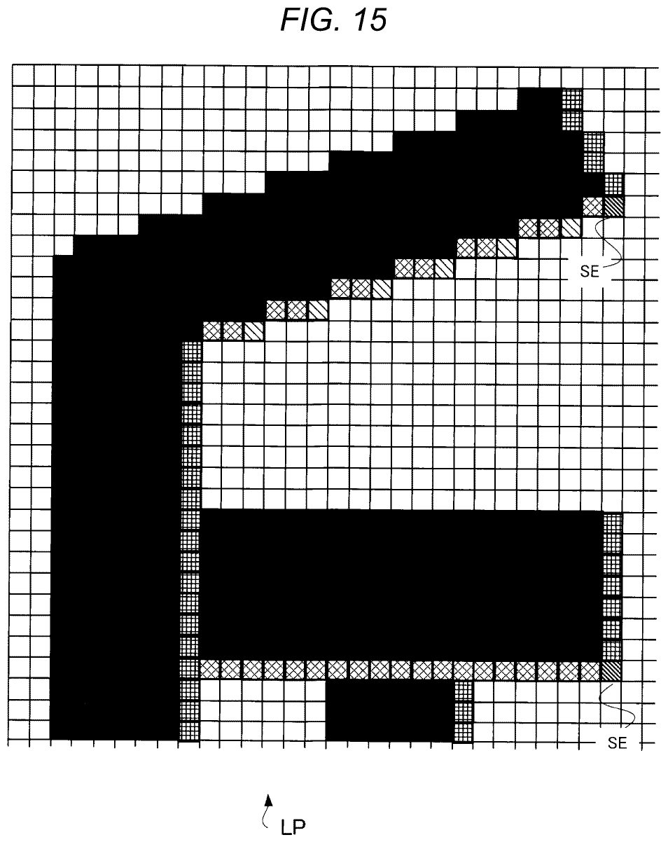

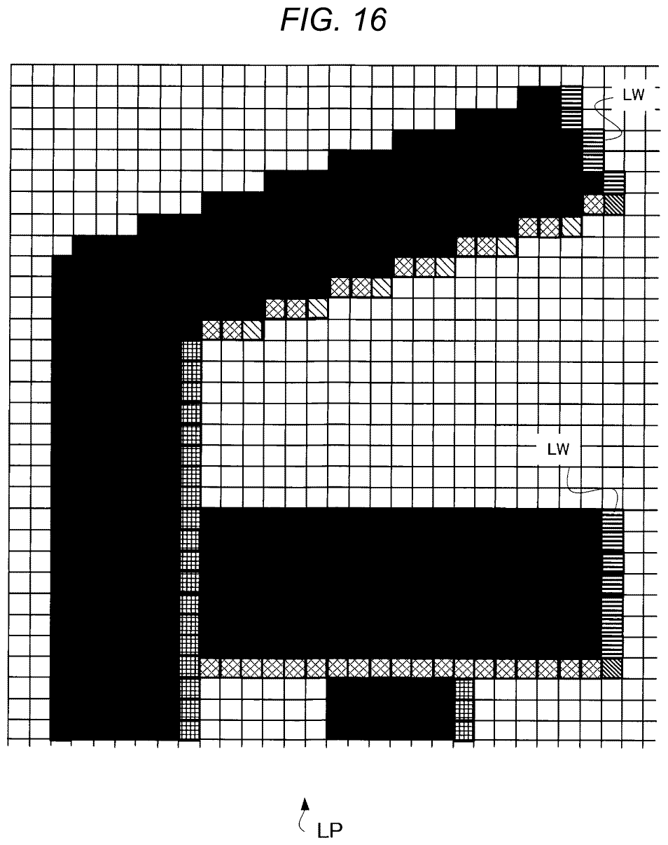

Then, the detector 123 detects the line width LW. Since the line width of the m-th stroke forming the character pattern LP is finite, among the portions detected as the vertical line edge EGv, the horizontal line edge EGb, or the corner edge EGc, the portion corresponding to the line width LW of the m-th stroke is unnecessary as the guide line AI1. Accordingly, it is necessary for the detector 123 to detect and delete the line width LW from the guide line AI1 to be projected. In FIG. 14, when the grid containing the corner edge EGc indicated by the fourth pattern is set as “grid of interest”, the detector 123 detects the grid of interest for which the grid A is contained in the vertical line edge EGv and the grid B is contained in the horizontal line edge EGb as “origin grid SE”. FIG. 15 shows the origin grids SE. In FIG. 15, the connection points JP indicated by the seventh pattern in FIG. 14 are indicated by the same pattern as that of the linear edges EGl to which the connection points are connected. In FIG. 15, the origin grid SE is indicated by the fifth pattern. Then, the detector 123 counts the number of grids of each of the edge EG extending upward and the edge EG extending leftward from the origin grid SE. Specifically, the edge EG extending upward includes a vertical edge EGv and a corner edge EGc. The edge EG extending leftward includes a horizontal edge EGb and a corner edge EGc. The detector 123 detects grids containing the edge EG having the smaller number of grids of the edge EG extending upward and the edge EG extending leftward as the line width LW. In FIG. 16, the line width LW is indicated by the sixth pattern.

Then, the detector 123 detects the first-type overlap OL1 and the second-type overlap OL2. When drawing a horizontal line such that the start point is located at an intermediate position in the longitudinal direction of the vertical line at painting of the road marking RM, the worker draws the horizontal line such that the start point of the horizontal line overlaps in a half of the width of the vertical line. When drawing a vertical line such that the start point is located at an intermediate position in the longitudinal direction of the horizontal line, the worker draws the vertical line such that the start point of the vertical line overlaps in a half of the line width of the horizontal line. Thereby, a gap produced between the vertical line and the horizontal line is prevented. The detector 123 detects the grids contained in the guide lines AI1 corresponding to the painting of these overlapping portions as the first type overlap OL1 and the second type overlap OL2.

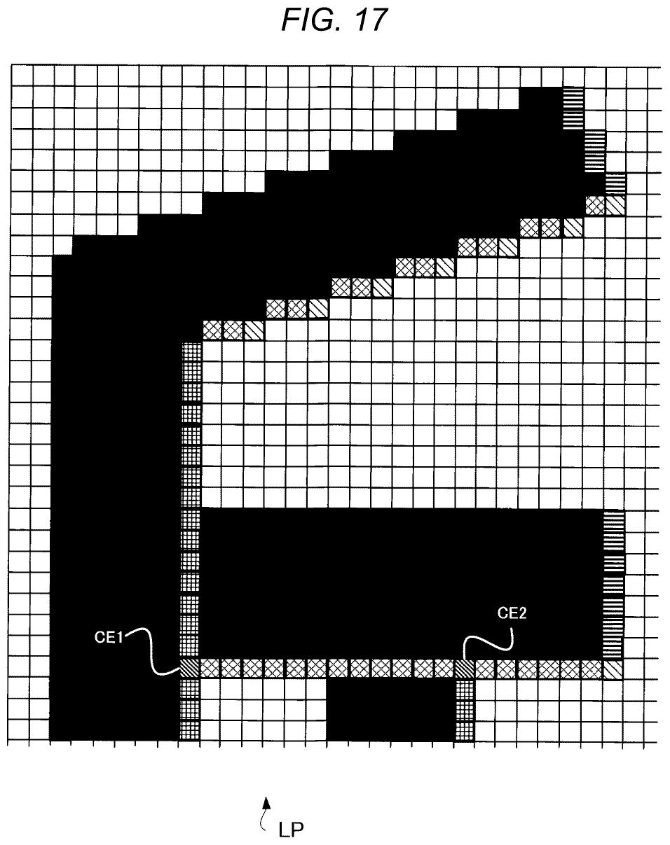

Therefore, the detector 123 detects “first contact grid CE1” as a grid in which the end of the horizontal line edge EGb contacts the vertical line edge EGv and “second contact grid CE2” as a grid in which the end of the vertical line edge EGv contacts the horizontal line edge EGb. When a plurality of edges EG form a line as a group, “the end of the edge EG” refers to the edge of the line in the longitudinal direction. FIG. 17 shows the first contact grid CE1 and the second contact grid CE2. In FIG. 17, the first contact grid CE1 and the second contact grid CE2 are indicated by the fifth pattern.

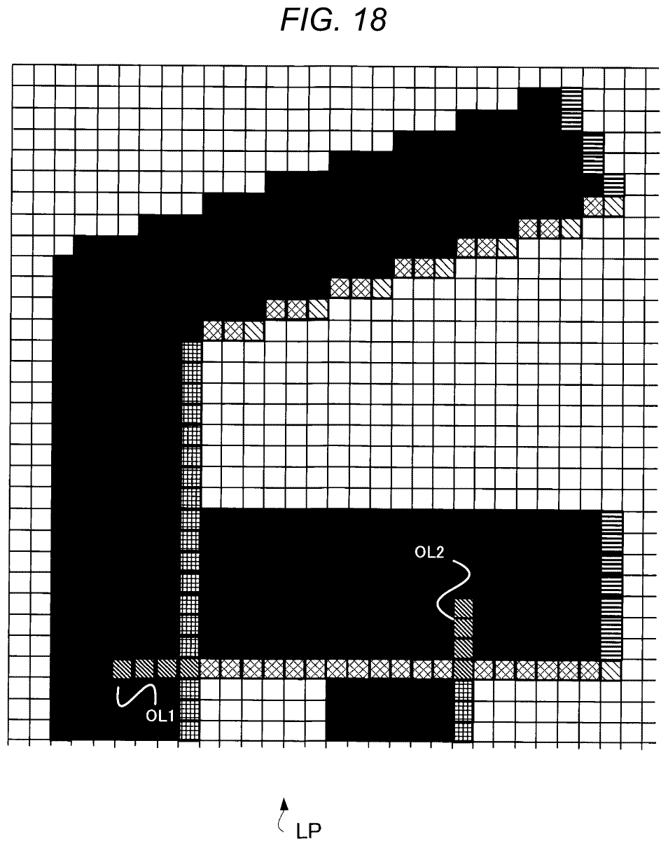

The detector 123 detects grids as an extension having a length corresponding to a half of the line width of the m-th stroke or the n-th stroke from each of the first contact grid CE1 and the second contact grid CE2 as each of the first-type overlap OL1 and the second-type overlap OL2. FIG. 18 shows the first-type overlap OL1 and the second-type overlap OL2. In FIG. 18, the first-type overlap OL1 and the second-type overlap OL2 are indicated by the fifth pattern.

Note that FIG. 18 shows an example in which grids as an extension having a length corresponding to a half of the line width of the m-th stroke or the n-th stroke from each of the first contact grid CE1 and the second contact grid CE2 are detected as each of the first-type overlap OL1 and the second-type overlap OL2. However, the length of the extension from each of the first contact grid CE1 and the second contact grid CE2 is not limited to the length corresponding to the half of the line width of the m-th stroke or the n-th stroke. The user U displays an operator for input of the extension length and inputs the extension length by pressing the fifth button BT5 contained in the user interface UI in FIG. 6. In this case, the detector 123 detects grids as an extension having the input length from each of the first contact grid CE1 and the second contact grid CE2 as each of the first-type overlap OL1 and the second-type overlap OL2. The input length corresponds to the length of each of the first-type overlap OL1 and the second-type overlap OL2.

Then, the detector 123 detects the through line PL. When the vertical line and the horizontal line are drawn from the same start point at painting of the road marking RM, if only the first-type overlap OL1 and the second-type overlap OL2 detected by the detector 123 are used as the guide lines AI1, the corners of the character pattern LP are recessed. In order to avoid this, when the vertical line and the horizontal line are drawn from the same start point, as an example, the worker extends the guide line AI1 for drawing the horizontal line to the full width of the vertical line. The detector 123 detects grids contained in the guide line AI1 extended to the full width of the vertical line as the through line PL.

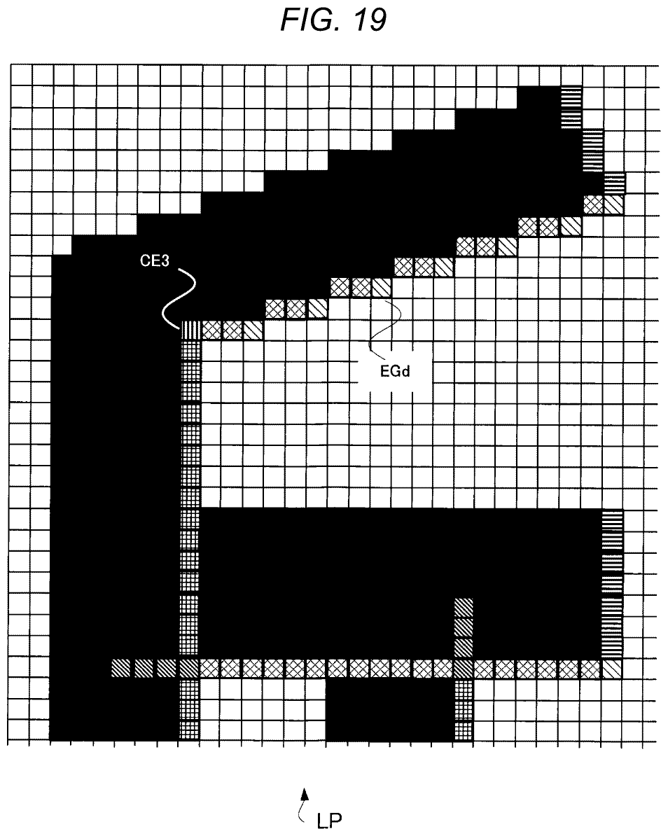

Therefore, the detector 123 detects “third contact grid CE3” as a grid in which the end of the horizontal line edge EGb contacts the end of the vertical line edge EGv. FIG. 19 shows the third contact grid CE3. In FIG. 19, the third contact grid CE3 is indicated by the seventh pattern.

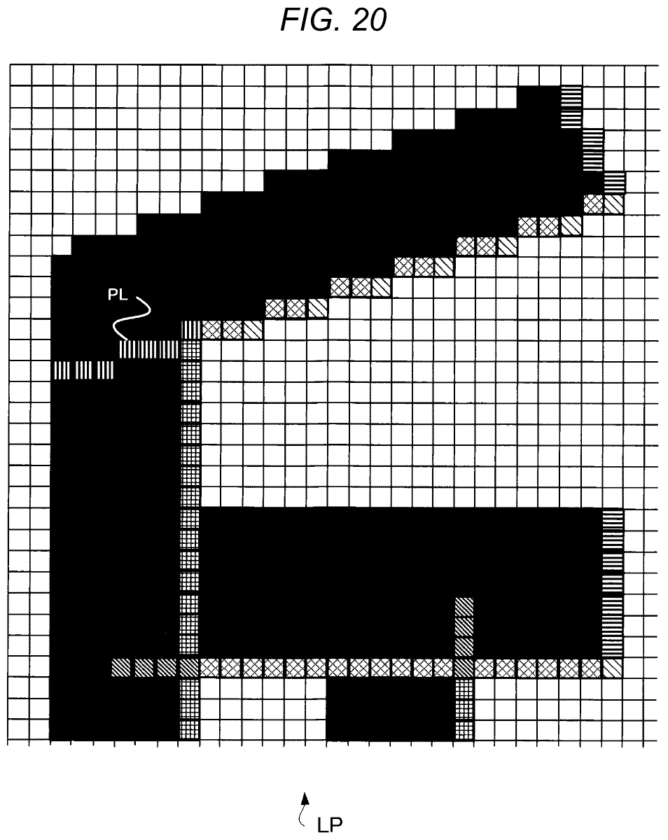

The detector 123 extends a diagonal line edge EGd shown in FIG. 19 from the third contact grid CE3 as the start point in a range overlapping with the character pattern LP. Specifically, the detector 123 reads the pattern shape of the diagonal line edge EGd, and detects a grid that is point-symmetrical to the diagonal line edge EGd in the range overlapping with the character pattern LP with the third contact grid CE3 in between as the through line PL. FIG. 20 shows the through line PL. In FIG. 20, the through line PL is indicated by the seventh pattern.

The detector 123 detects grids corresponding to the vertical line edge EGv, the horizontal line edge EGb, the corner edge EGc, the first-type overlap OL1, the second-type overlap OL2, and the through line PL among the grids indicated by using various patterns in FIG. 20 as the guide lines AI1.

Further, the detector 123 detects the masking tape position AI2. For example, when detecting a portion in which an end in the longitudinal direction of the diagonal m-th stroke contained in the first character L1 to the third character L3 of the character pattern LP is cut vertically or horizontally, the detector 123 first detects both ends in the longitudinal direction of the diagonal m-th stroke in the character pattern LP. Then, when the diagonal m-th stroke itself is a horizontal line, the detector 123 determines whether both ends of the m-th stroke are vertical. When the ends are vertical, the detector 123 detects the vertical ends as the masking tape position AI2. When the diagonal m-th stroke itself is a vertical line, the detector 123 determines whether both ends of the m-th stroke are horizontal. When the ends are horizontal, the detector 123 detects the horizontal ends as the masking tape position AI2.

In addition, for example, in positions as start points for both vertical lines and horizontal lines in the first character L1 to the third character L3 of the character pattern LP, when detecting a portion in which at least one of the vertical line and the horizontal line is a diagonal line, the detector 123 first detects the positions as start points for both vertical lines and horizontal lines in the first character L1 to the third character L3. Then, the detector 123 determines whether at least one of the vertical line and the horizontal line starting from the detected position is a diagonal line. Finally, the detector 123 detects the end at the opposite side to the position as the start point for the vertical line or the horizontal line determined as the diagonal line as the masking tape position AI2. Here, the “diagonal line” refers to a straight line whose angle with respect to a straight line in the horizontal direction or a straight line in the vertical direction exceeds a predetermined value set in advance.

In FIG. 5, the setting unit 124 sets the output image OI according to the input by the user U to the user interface UI received by the receiver 122. More specifically, as described above, the detector 123 detects an element related to the character pattern LP as the original image. The setting unit 124 sets the output image OI using the detected element according to the input by the user U.

Specifically, as described above, the user U operates each operator contained in the user interface UI shown in FIG. 6, and thereby, an image corresponding to the output image OI is displayed in the display window DW. The setting unit 124 sets the displayed image as the output image OI. If the image displayed in the display window DW is not suitable as the output image OI, the user U changes the image displayed in the display window DW by operating each operator contained in the user interface UI.

In FIG. 5, the projection controller 125 controls the projector 20 to project the output image OI set by the setting unit 124 onto the road surface RS. The output image OI may be an image of only the character pattern LP shown in FIG. 7, an image of only the guide lines AI1, or an image of only the masking tape positions AI2. Alternatively, the output image OI may be an image on which two or more of these three elements are superimposed. Further, the output image OI may include the auxiliary line AL for assisting the painting of the road marking RM. The auxiliary line AL may be the above described line width LW as an example. Or, the auxiliary line AL may be, for example, a center line of each of the road marking RM, the first character L1, the second character L2, and the third character L3. Or, the auxiliary line AL may be a cross line.

In the output image OI, the color of the outline of the character pattern LP and the color of the guide line AI1 may be different from each other. The color of the outline of the character pattern LP is an example of “first color”. The color of the guide line AI1 is an example of “second color”. The image of the masking tape position AI2 may be different from the color of the outline of the character pattern LP or the color of the guide line AI1. The colors used for the output image OI may be the same as the colors used for display of the respective elements in the display window DW, or may be different at least partially.

The user U controls the projector 20 to project the output image OI set by the setting unit 124 onto the road surface RS by pressing the fourth button BT4 contained in the user interface UI of FIG. 6. Further, the user U can switch the output image OI to be projected on the road surface RS among an image containing only the character pattern LP, an image containing only the guide lines AI1, an image containing only the masking tape positions AI2, and an image in which two or more of these three elements are superimposed by pressing the fifth button BT5 contained in the user interface UI.

Furthermore, the user U may control the projector 20 to project a painting image in which the inside of the outline of the character pattern LP is filled with a painting color separately from the output image OI on the road surface RS by pressing the fifth button BT5.

### 1-3: Configuration of Projector

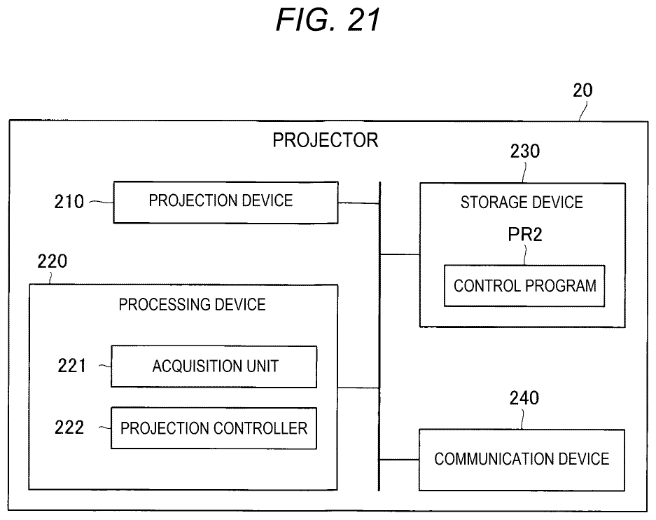

FIG. 21 is a block diagram showing a configuration example of the projector 20. The projector 20 includes a projection device 210, a processing device 220, a storage device 230, and a communication device 240. The respective elements of the projector 20 are connected to one another by a single bus or a plurality of buses for communicating information. Further, each element of the projector 20 may include a single or a plurality of devices, and part of the elements of the projector 20 may be omitted.

The projection device 210 is a device that projects an image represented by an image signal acquired by an acquisition unit 221, which will be described later, on a screen, a wall, or the like. The projection device 210 projects various images under the control of the processing device 220. The projection device 210 includes, for example, a light source, a liquid crystal panel, and a projection lens, modulates light from the light source using the liquid crystal panel, and projects the modulated light onto a screen, a wall, or the like via the projection lens.

The processing device 220 is a processor that controls the entire projector 20, and includes, for example, a single or a plurality of chips. The processing device 220 includes, for example, a central processing unit (CPU) including an interface with a peripheral device, an arithmetic device, a register, and the like. Apart or all of the functions of the processing device 220 may be realized by hardware such as a DSP, an ASIC, a PLD, or an FPGA. The processing device 220 executes various kinds of processing in parallel or sequentially.

The storage device 230 is a storage medium readable by the processing device 220 and stores a plurality of programs including a control program PR2 executed by the processing device 220. The storage device 230 may include at least one of a ROM (Read Only Memory), an EPROM (Erasable Programmable ROM), an EEPROM (Electrical Erasable Programmable ROM), and a RAM (Random Access Memory), for example. The storage device 230 may be referred to as a register, a cache, a main memory, or a main storage device.

The communication device 240 is hardware serving as a transmitting and receiving device for communicating with another device. The communication device 240 is also called, for example, a network device, a network controller, a network card, or a communication module. The communication device 240 may include a connector for wired connection and an interface circuit corresponding to the connector. The communication device 240 may include a wireless communication interface. Examples of the connector and the interface circuit for wired connection include those conforming to wired LAN, IEEE 1394, and USB. Further, examples of the wireless communication interface include an interface conforming to a wireless LAN or Bluetooth (registered trademark).

The processing device 220 functions as the acquisition unit 221 and the projection controller 222 by reading and executing the control program PR2 from the storage device 230. The control program PR2 may be transmitted from another device such as a server that manages the projector 20 via a communication network.

The acquisition unit 221 acquires an image signal corresponding to the output image OI and a control signal for controlling the projector 20 from the information processing device 10.

The projection controller 222 controls the projection device 210 to project the output image OI corresponding to the image signal acquired by the acquisition unit 221 onto the road surface RS based on the control signal acquired by the acquisition unit 221.

In the embodiment, the projection device 210 is an example of “optical device”. The projector 20 is another example of “optical device”.

### 1-4: Operation of Information Processing Device

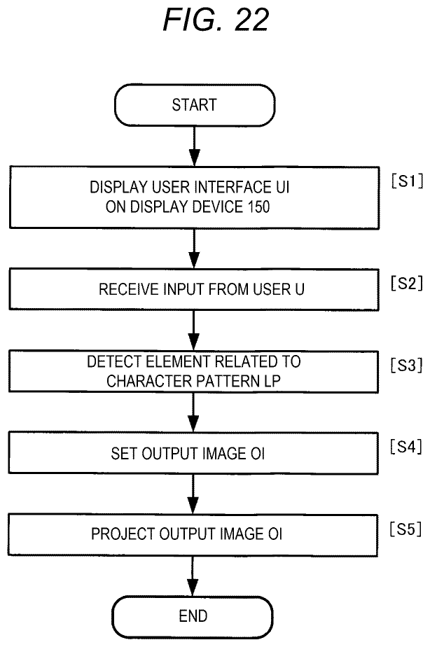

FIG. 22 is a flowchart showing the operation of the information processing device 10.

In step S1, the processing device 120 functions as the display controller 121. The processing device 120 displays the user interface UI on the display device 150 based on the original image relating to the road marking RM. The user interface UI is used for setting of the output image OI containing a line drawing as a reference for painting of the road marking RM on the road surface RS.

In step S2, the processing device 120 functions as the receiver 122. The processing device 120 receives input from the user U for setting the output image OI via the user interface UI.

In step S3, the processing device 120 functions as the detector 123. The processing device 120 detects an element related to the character pattern LP as the original image.

In step S4, the processing device 120 functions as the setting unit 124. The processing device 120 sets the output image OI according to the input by the user U to the user interface UI received in step S2.

In step S5, the processing device 120 functions as the projection controller 125. The processing device 120 controls the projector 20 to project the output image OI set in step S4 onto the road surface RS.

### 2: Modification Examples

The above described configurations can variously be modified. Specific modified configurations will be exemplified below. The configurations exemplified below and the configurations shown in the above described embodiment may be combined as appropriate within a mutually consistent range. Note that, in the modification examples exemplified below, elements having equivalent actions and functions to those of the embodiment will be denoted by the signs referred to in the above description and the detailed description thereof will be omitted as appropriate.

### 2-1: Modification Example 1

In the above described embodiment, the display controller 121 controls the display device 150 to display the user interface UI. In addition thereto, the projection controller 125 may control the projector 20 to project an image showing the user interface UI onto the road surface RS.

### 2-2: Modification Example 2

In the above described embodiment, the display setting field DS of the user interface UI is used for setting whether to display the character pattern LP, the vertical line edge EGv, the horizontal line edge EGb, the corner edge EGc, the first-type overlap OL1, the second-type overlap OL2, the line width LW, the through line PL, and the masking tape position AI2. However, the display setting field DS may be used for setting whether to display another element.

The “other element” may be, for example, at painting of the road marking RM, at least one of a start point and an end point of the painting. In this case, the input from the user U received by the receiver 122 includes at least one of input to select whether to display the start point of the painting and input to select whether to display the end point of the painting in addition to the input in the above described embodiment.

Further, in the display setting field DS, an operator for changing the line width of the outline of the character pattern LP, an operator for changing the color of the outline of the character pattern LP, an operator for internal painting of the inside of the outline of the character pattern LP, and an operator for selecting the color for the internal painting may be displayed. The color for the internal painting preferably includes a color used for actual painting.

Furthermore, in the display setting field DS, operators for changing the display colors of the vertical line edge EGv, the horizontal line edge EGb, the corner edge EGc, the first-type overlap OL1, the second-type overlap OL2, the line width portion LW, the through line PL, and the masking tape position AI2 and operators for changing the line widths of the lines indicating these elements may be displayed.

### 2-3: Modification Example 3

In the above described embodiment, for example, as shown in FIG. 2, the information processing device 10 and the projector 20 are realized as separate devices. However, the information processing device 10 and the projector 20 may be realized in a single housing.

### 2-4: Modification Example 4

In the above described embodiment, the output image OI is set collectively for three characters contained in the road marking RM via the user interface UI. However, the number of characters to be set in the output image OI is not limited thereto. For example, the characters may be sequentially set one by one, or two characters or four or more characters may be collectively set. Further, the user interface UI may contain characters to be set, or an operator for designating the number of characters to be collectively set.

### 3: Summary of Present Disclosure

A summary of the present disclosure is appended

below.

(Appendix 1) A projection method includes displaying a user interface for setting an output image based on an original image relating to a road marking, the output image containing a line drawing serving as a reference for painting of the road marking on a road surface, receiving input to set the output image via the user interface, and projecting the output image from an optical device onto the road surface.

Accordingly, in order to paint the road marking RM on the road surface, the work efficiency of drawing a line drawing serving as a reference used for the painting on the road surface RS is increased.

More specifically, in a general painting method of the road marking, a worker manually draws a chalk line as a guide line using a marker. Since the drawing of the guide line by the chalk line occupies a larger amount of the construction time for painting the road marking, work efficiency is required. Further, since an artisan skill is necessary for drawing of a chalk line as a guide line, a method that enables even a beginner to easily draw a guide line is required. According to the projection method of the present disclosure, the guide line as the line drawing serving as the reference is projected on the road surface, and thereby, work efficiency is increased and the guide line can be drawn even by a beginner.

Further, the character pattern contained in the road marking and the guide line can be visually recognized at the same time, and thereby, an error in drawing of the guide line can be prevented and the work efficiency is further increased. According to the projection method of the present disclosure, the work efficiency of painting the road marking is increased, and therefore, the closing time of the road can be shortened. Thus, according to the projection method of the present disclosure, traffic congestion due to one-way alternate traffic at a site can be solved and risks of a rear-end accident and the like can be reduced.

(Appendix 2) The projection method according to Appendix 1, wherein the input to set the output image includes at least one of input to select at least a part of an outline of the original image, input to select all the outline of the original image, input to select whether to display an indication image indicating a position on the road surface to which an attachment object for defining an outline of the painting is attached, input to select whether to display a start point of the painting, input to select whether to display an end point of the painting, and input to select whether to display an auxiliary line different from the original image for assisting the painting of the road marking.

Accordingly, the user can set the output image OI to be projected on the road surface RS based on various kinds of input by the user using the projection method of the present disclosure. The various kinds of input include input to select whether to display an indication image indicating a position to which a masking tape for defining an outline of the painting is attached. As a result, according to the projection method of the present disclosure, forgetting to attach the masking tape can be prevented. As a result, visibility of the road marking is increased and an occurrence of an accident based on false recognition by a driver driving a vehicle is suppressed. Thus, the projection method of the present disclosure can contribute to improvement in traffic safety.

(Appendix 3) The projection method according to Appendix 2, wherein the input to set the output image includes input to select at least a part of the outline of the original image, and projecting the output image is projecting an output image containing a line segment indicating the at least a part of the outline of the original image.

Accordingly, the user can project the guide line on the road surface using the projection method of the present disclosure.

(Appendix 4) The projection method according to Appendix 3, wherein the input to set the output image includes input to select all the outline of the original image, and projecting the output image is projecting the output image containing a line segment in a first color indicating the all the outline of the original image and a line segment in a second color different from the first color indicating the at least a part of the outline of the original image.

Accordingly, the user can project the outline of the character pattern LP and the guide line on the road surface using the projection method of the present disclosure. Further, according to the projection method of the present disclosure, the colors used for the outline of the character pattern and the guide line are different from each other, and thereby, the visibility of both lines can be increased.

(Appendix 5) The projection method according to any one of Appendixes 1 to 3, further includes, when the input to set the output image is input to select to display a completion drawing of the road marking, projecting a painting image having a same outline as the outline of the output image with an inside of the same outline filled with a color of the painting from the optical device onto the road surface.

Accordingly, the user can project a painting image as a completion drawing of the road marking on the road surface using the projection method of the present disclosure. As a result, work efficiency when the road marking is pained on the road surface RS is increased.

(Appendix 6) The projection method according to Appendix 3 or 4, wherein the input to select at least a part of the outline of the original image includes input to select at least one of a straight line in a first direction of the outline of the original image and a straight line in a second direction orthogonal to the first direction of the outline of the original image.

Accordingly, the user can selectively project, the vertical guide line and the horizontal guide line of the guide lines on the road surface using the projection method of the present disclosure.

(Appendix 7) The projection method according to Appendix 3, further includes, when the input to select at least a part of the outline of the original image is input to select a straight line in a first direction of the outline of the original image and a straight line in a second direction different from the first direction of the outline of the original image, receiving input to select whether to extend one of the straight line in the first direction and the straight line in the second direction to an inside of the outline of the original image at an intersection of the straight line in the first direction and the straight line in the second direction.

Accordingly, the user can project the first-type overlap and the second-type overlap on the road surface using the projection method of the present disclosure.

(Appendix 8) The projection method according to Appendix 7, further includes, when receiving input to select to extend the one of the straight line in the first direction and the straight line in the second direction to the inside of the outline of the original image, receiving input indicating an amount of the extension of the one of the straight line in the first direction and the straight line in the second direction.

Accordingly, the user can set lengths of the first-type overlap and the second-type overlap using the projection method of the present disclosure.

(Appendix 9) The projection method according to Appendix 1, further includes displaying the output image on a display device different from the optical device.

Thereby, the user can check the output image on the display device.

(Appendix 10) A projection system includes a processing device configured to execute displaying a user interface for setting an output image based on an original image relating to a road marking, the output image containing a line drawing serving as a reference for painting of the road marking on a road surface, receiving input to set the output image via the user interface, and projecting the output image from an optical device onto the road surface.

Accordingly, in order to paint the road marking RM on the road surface, the work efficiency of drawing the auxiliary line used for the painting on the road surface is increased.

More specifically, in a general painting method of the road marking, a worker manually draws a chalk line as a guide line using a marker. Since the drawing of the guide line by the chalk line occupies a larger amount of the construction time for painting the road marking, work efficiency is required. Further, since an artisan skill is necessary for drawing of a chalk line as a guide line, a method that enables even a beginner to easily draw a guide line is required. According to the projection system of the present disclosure, the guide line is projected on the road surface, and thereby, work efficiency is increased and the guide line can be drawn even by a beginner.

Further, the character pattern contained in the road marking and the guide line can be visually recognized at the same time, and thereby, an error in drawing of the guide line can be prevented and the work efficiency is further increased. According to the projection system of the present disclosure, the work efficiency of painting the road marking is increased, and therefore, the closing time of the road can be shortened. Thus, according to the projection system of the present disclosure, traffic congestion due to one-way alternate traffic at a site can be solved and risks of a rear-end accident and the like can be reduced.

(Appendix 11) A non-transitory computer-readable storage medium storing a program for information processing causes a computer to execute displaying a user interface for setting an output image based on an original image relating to a road marking, the output image containing a line drawing serving as a reference for painting of the road marking on a road surface, receiving input to set the output image via the user interface, and projecting the output image from an optical device onto the road surface.

Accordingly, in order to paint the road marking RM on the road surface RS, the work efficiency of drawing the auxiliary line AL used for the painting on the road surface RS is increased.

More specifically, in a general painting method of the road marking RM, a worker manually draws a chalk line as a guide line using a marker. Since the drawing of the guide line by the chalk line occupies a larger amount of the construction time for painting the road marking RM, work efficiency is required. Further, since an artisan skill is necessary for drawing of a chalk line as a guide line, a method that enables even a beginner to easily draw a guide line is required. According to the information processing program of the present disclosure, the guide line AI1 is projected on the road surface RS, and thereby, work efficiency is increased and the guide line AI1 can be drawn even by a beginner.

Further, the character pattern LP contained in the road marking RM and the guide line AI1 can be visually recognized at the same time, and thereby, an error in drawing of the guide line AI1 can be prevented and the work efficiency is further increased. According to the non-transitory computer-readable storage medium storing a program for information processing of the present disclosure, the work efficiency of painting the road marking RM is increased, and therefore, the closing time of the road can be shortened. Thus, according to the non-transitory computer-readable storage medium storing a program for information processing of the present disclosure, traffic congestion due to one-way alternate traffic at a site can be solved and risks of a rear-end accident and the like can be reduced.

What is claimed is:

1. A projection method comprising:
displaying a user interface for setting an output image based on an original image relating to a road marking, the output image containing a line drawing serving as a reference for painting of the road marking on a road surface;
receiving input to set the output image via the user interface; and
projecting the output image from an optical device onto the road surface.

2. The projection method according to claim 1, wherein
the input to set the output image includes at least one of:
input to select at least a part of an outline of the original image;
input to select all the outline of the original image;
input to select whether to display an indication image indicating a position on the road surface to which an attachment object for defining an outline of the painting is attached;
input to select whether to display a start point of the painting;
input to select whether to display an end point of the painting; and
input to select whether to display an auxiliary line different from the original image for assisting the painting of the road marking.

3. The projection method according to claim 2, wherein
the input to set the output image includes input to select at least a part of the outline of the original image, and
projecting the output image is projecting an output image containing a line segment indicating the at least a part of the outline of the original image.

4. The projection method according to claim 3, wherein
the input to set the output image includes input to select all the outline of the original image, and
projecting the output image is projecting the output image containing a line segment in a first color indicating the all the outline of the original image and a line segment in a second color different from the first color indicating the at least a part of the outline of the original image.

5. The projection method according to claim 1,
wherein the input to set the output image is input to select to display a completion drawing of the road marking,
the method further comprising projecting a painting image having a same outline as an outline of the output image with an inside of the same outline filled with a color of the painting from the optical device onto the road surface.

6. The projection method according to claim 3, wherein
the input to select at least a part of the outline of the original image includes input to select at least one of a straight line in a first direction of the outline of the original image and a straight line in a second direction orthogonal to the first direction of the outline of the original image.

7. The projection method according to claim 3, further comprising, when the input to select at least a part of the outline of the original image is input to select a straight line in a first direction of the outline of the original image and a straight line in a second direction different from the first direction of the outline of the original image, receiving input to select whether to extend one of the straight line in the first direction and the straight line in the second direction to an inside of the outline of the original image at an intersection of the straight line in the first direction and the straight line in the second direction.

8. The projection method according to claim 7, further comprising, when receiving input to select to extend the one of the straight line in the first direction and the straight line in the second direction to the inside of the outline of the original image, receiving input indicating an amount of the extension of the one of the straight line in the first direction and the straight line in the second direction.

9. The projection method according to claim 1, further comprising displaying the output image on a display device different from the optical device.

10. A projection system comprising a processing device configured to execute:
displaying a user interface for setting an output image based on an original image relating to a road marking, the output image containing a line drawing serving as a reference for painting of the road marking on a road surface;
receiving input to set the output image via the user interface; and
projecting the output image from an optical device onto the road surface.

11. A non-transitory computer-readable storage medium storing a program for information processing causing a computer to execute:
displaying a user interface for setting an output image based on an original image relating to a road marking, the output image containing the line drawing serving as a reference for painting of a road marking on a road surface;
receiving input to set the output image via the user interface; and
projecting the output image from an optical device onto the road surface.
